(19) United States
(12) Patent Application Publication
(10) Pub. No.: US 2026/0304338 A1
(43) Pub. Date: Oct. 1, 2026

(54) RADIO CONDITION BASED USER DEVICE CAPABILITY SELECTION IN WIRELESS COMMUNICATION NETWORKS

(71) Applicant: T-MOBILE INNOVATIONS LLC, Overland Park, KS (US)

(72) Inventors: Christopher Gunn, Woodinville, WA (US); Christopher Bailey, Overland Park, KS (US); Maksym Siryy, Overland Park, KS (US)

(21) Appl. No.: 19/090,650

(22) Filed: Mar. 26, 2025

(51) Int. Cl. H04W 60/00; H04B 17/336; H04W 24/10

(52) U.S. Cl. CPC H04W 60/00; H04B 17/336; H04W 24/10

(57) ABSTRACT

Various embodiments include a system that comprises processing circuitry and radio circuitry of a user device. The radio circuitry wirelessly attaches to an access node of a communication network. The radio circuitry measures a radio metric associated with access node. The processing circuitry filters a list of user device capabilities based on the radio metric to result in a filtered list of user device capabilities. The radio circuitry wirelessly transfers a capability report to the access node. The capability report includes the filtered list of user device capabilities.

### TECHNICAL FIELD

Various embodiments of the present technology relate to wireless communications, and more specifically, to selectively reporting user device capabilities based on measured radio conditions.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless user devices comprise various capabilities to communicate with the RAN. Exemplary capabilities include 5GNR, LTE, Time Division Duplex Uplink Massive Input Massive Output (TDD UL MIMO), Uplink Fifth Generation New Radio Carrier Aggregation Time division Duplex and Frequency Division Duplex (UL 5GNR CA TDD/FDD), Power Control 1.5 (PC 1.5), and the like. The wireless user devices indicate their capabilities to the network core during network registration. The network core interfaces with the RAN to enable radio technologies to serve the wireless user devices based on the capabilities reported during network registration.

Some user device capabilities are incompatible with other device capabilities. For example, a wireless user device typically cannot simultaneously use TDD UL MIMO and UL 5GNR CA TDD/FDD to transfer uplink user data to the RAN. Additionally, some user device capabilities are more suitable for certain radio conditions than other radio conditions. For example, TDD UL MIMO is more effective than UL 5GNR CA TDD/FDD when radio interference is high, and signal strength is strong. Likewise, UL 5GNR CA TDD/FDD is more effective than TDD UL MIMO when radio interference is low, and signal strength is weak. Some user devices comprise an uplink transmit switching capability which allows these user devices to switch between uplink radio technologies (e.g., UL 5GNR CA TDD/FDD, TDD UL MIMO, etc.) based on the radio conditions experienced by these user devices.

Other user devices lack the capability for uplink transmit switching. These user devices typically indicate all of their capabilities to the network core during registration. For user devices that lack the uplink transmit switching capability, the radio technologies selected by the network core to serve the user devices are typically static. For example, the network core will not reselect a radio technology for a user device while the user device is registered on the network. As such, as the radio conditions change at the location of user devices that lack the capability for uplink transmit switching, these user devices may be restricted to using radio technologies that are not well suited for the radio conditions experienced by the user devices. This degrades the overall user experience.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless communications. Some embodiments comprise a method. The method comprises wirelessly attaching to an access node of a communication network. The method further comprises measuring a radio metric associated with the access node. The method further comprises filtering a list of user device capabilities based on the radio metric to result in a filtered list of user device capabilities. The method further comprises wirelessly transferring a capability report to the access node. The capability report includes the filtered list of user device capabilities.

Some embodiments comprise a method. The method comprises receiving an instruction from a core network in a communication network to serve a user device using a radio technology from a set of available radio technologies based on a user device capability indicated in a capability report associated with the user device. The method further comprises wirelessly exchanging user data with the user device using the radio technology. The method further comprises wirelessly transferring a measurement command to the user device that directs the user device to measure a radio metric. The method further comprises wirelessly receiving a measurement report from the user device that indicates the radio metric. The method further comprises directing the user device to update the capability report based on the radio metric. The user device selects a new device capability based on the radio metric and transfers an updated capability that indicates the new device capability.

Some embodiments comprise a system. The system comprises processing circuitry and radio circuitry of a user device. The radio circuitry wirelessly attaches to an access node of a communication network. The radio circuitry measures a radio metric associated with access node. The processing circuitry filters a list of user device capabilities based on the radio metric to result in a filtered list of user device capabilities. The radio circuitry wirelessly transfers a capability report to the access node. The capability report includes the filtered list of user device capabilities.

Some embodiments comprise a system. The system comprises node circuitry and radio circuitry of an access node. The node circuitry receives an instruction from a core network in a communication network to serve a user device using a radio technology from a set of available radio technologies based on a user device capability indicated in a capability report associated with the user device. The radio circuitry wirelessly exchanges user data with the user device using the radio technology. The radio circuitry wirelessly transfers a measurement command to the user device that directs the user device to measure a radio metric. The radio circuitry wirelessly receives a measurement report from the user device that indicates the radio metric. The node circuitry directs the user device to update the capability report based on the radio metric. The user device selects a new device capability based on the radio metric and transfers an updated capability that indicates the new device capability.

Some embodiments comprise one or more non-transitory computer readable storage media having program instructions stored thereon. When executed by a computing system, the program instructions direct the computing system to perform operations. The operations comprise controlling a radio to wirelessly attach to an access node of a communication network. The operations further comprise controlling the radio to measure a radio metric associated with the access node. The operations further comprise filtering a list of user device capabilities based on the radio metric to result in a filtered list of user device capabilities. The operations further comprise controlling the radio to wirelessly transfer a capability report to the access node. The capability report includes the filtered list of user device capabilities.

Some embodiments comprise one or more non-transitory computer readable storage media having program instructions stored thereon. When executed by a computing system, the program instructions direct the computing system to perform operations. The operations comprise receiving an instruction from a core network in a communication network to serve a user device using a radio technology from a set of available radio technologies based on a user device capability indicated in a capability report associated with the user device. The operations further comprise controlling a radio to wirelessly exchange user data with the user device using the radio technology. The operations further comprise controlling the radio to wirelessly transfer a measurement command to the user device that directs the user device to measure a radio metric. The operations further comprise controlling the radio to wirelessly receive a measurement report from the user device that indicates the radio metric. The operations further comprise controlling the radio to direct the user device to update the capability report based on the radio metric. The user device selects a new device capability based on the radio metric and transfers an updated capability that indicates the new device capability.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to selectively report user device capabilities based on measured radio conditions.

FIG. 2 illustrates a first exemplary operation of the communication network to selectively report user device capabilities based on measured radio conditions.

FIG. 3 illustrates a second exemplary operation of the communication network to selectively report user device capabilities based on measured radio conditions.

FIG. 4 illustrates a third exemplary operation of the communication network to selectively report user device capabilities based on measured radio conditions.

FIG. 5 illustrates an example of a Fifth Generation (5G) communication network to selectively report user device capabilities based on measured radio conditions.

FIG. 6 illustrates an example of a 5G User Equipment (UE) in the 5G communication network that selectively reports user device capabilities based on measured radio conditions.

FIG. 7 illustrates an example of a 5G gNodeB in the 5G communication network that selectively reports user device capabilities based on measured radio conditions.

FIG. 8 illustrates an example of a 5G data center in the 5G communication network that selectively reports user device capabilities based on measured radio conditions.

FIG. 9 further illustrates the 5G data center in the 5G communication network that selectively reports user device capabilities based on measured radio conditions.

FIG. 10 illustrates an exemplary operation of the 5G communication network to selectively report user device capabilities based on measured radio conditions.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In conventional wireless communication networks, a user device transfers a registration request to a core network controller to receive wireless data services. The registration request includes a capability report that lists the capabilities of the user device. The capability list indicates the uplink and downlink radio technologies the user device can use to communicate with a wireless access node. The core network controller selects radio technologies to serve the user device based on the capability list and directs the wireless access node to serve the user device using the selected technologies. The various radio technologies available to serve the user device are best suited for different radio conditions. Some radio technologies cannot be simultaneously used with other technologies. User devices do not consider current radio conditions when reporting their capabilities to the network controller. When the user device lacks the capability for uplink transmit switching (e.g., switching between uplink radio technologies), the user device may be assigned to a radio technology that is not suited for the radio conditions experienced by the user device. This degrades the overall user experience.

To overcome the above-described problems in conventional wireless communication networks, various embodiments of the present technology relate to selectively reporting user device capabilities based on measured radio conditions. When a user device attaches to a wireless access node, the user device measures a radio metric associated with the access node. The user device then filters its capability list based on the measured radio metric. The filtering selects device capabilities suited for the measured radio metric and excludes device capabilities that are incompatible with the selected capabilities. The user device transfers the filtered capability list to the access node. The access node interfaces with core network entities to serve the user device over radio technologies based on the filtered capability list. By filtering its capability list based on the radio conditions experienced by the user device, the user device inhibits the communication network from serving the user device using a radio technology that is unsuited for the radio conditions experienced by the user device. This improves the overall user experience. Now referring to the Figures.

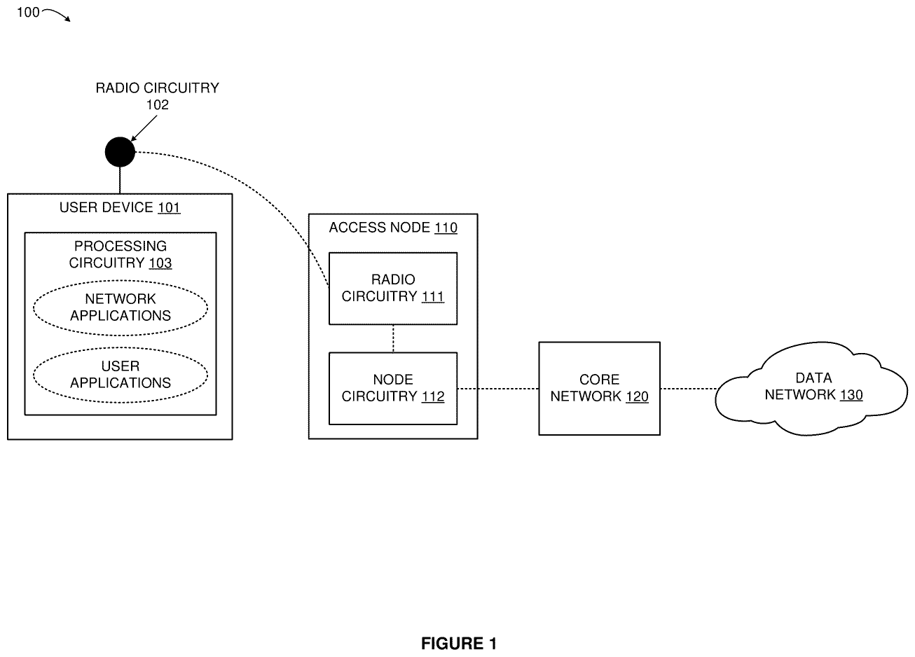

FIG. 1 illustrates communication network 100 to selectively report user device capabilities based on measured radio conditions. Communication network 100 provides services like media-streaming, media-broadcasting, internet-access, voice/video calling, text messaging, online gaming, social media, machine communications, remote device control, or some other wireless communications product. Communication network 100 comprises user device 101, access node 110, core network 120, and data network 130. User device 101 comprises radio circuitry 102 and processing circuitry 103. Processing circuitry 103 stores network applications and user applications. Access node 110 comprises radio circuitry 111 and node circuitry 112. In other examples, communication network 100 may comprise additional or different elements than those illustrated in FIG. 1.

Various examples of network operation and configuration are described herein. In some examples, user device 101 attaches to access node 110. User device 101 exchanges signaling with access node 110 to establish wireless data and signaling links. User device 101 measures a radio metric associated with access node 110. For example, user device 101 may measure Signal-To-Interference-Plus-Noise Ratio (SINR) and/or Received Signal Received Power (RSRP) of the reference signal or synchronization signal broadcast by access node 110. User device 101 filters a list of its device capabilities based on the measured radio metric to generate a filtered list of its device capabilities. The filtered list of device capabilities includes a device capability selected based on the measured radio metric and omits other device capabilities that are not compatible with the selected device capability. User device 101 may compare the measured radio metric(s) to a radio metric threshold and filter the lister of device capabilities based on the threshold comparison(s). When user device 101 measures multiple radio metrics (e.g., SINR and RSRP), user device 101 may calculate a weighted (or unweighted) sum of the multiple radio metrics to generate a radio metric score. User device 101 may then compare the score to a radio metric threshold and filter the list of device capabilities based on the comparison.

User device 101 wirelessly transfers a capability report to core network 120 over access node 110. The capability report includes the filtered list of device capabilities. Core network 120 selects a radio technology from a set of available radio technologies to serve user device 101 based on the capability report. For example, core network 120 may select the radio technology based on the selected device capability indicated in the filtered list of device capabilities. Core network 120 instructs access node 110 to serve user device 101 using the selected radio technology. Access node 110 establishes a data link with user device 101 using the selected radio technology. User device 101 exchanges user data with data network 130 over access node 110 and core network 120 using the selected radio technology.

During user device 101's data session on communication network 100, access node 110 directs user device 101 to measure the radio metric associated with access node 110. User device 101 measures the radio metric in response to the direction and wirelessly transfers a measurement report that indicates the measured radio metric to access node 110. Access node 110 directs user device 101 to update its capability report based on the measured radio metric. For example, the radio conditions at the location of user device 101 may change from when user device first attaches to access node 110 to when user device 101 receives the direction to measure the radio metric. The change in radio conditions may decrease the effectiveness of the originally selected radio technology with respect to other radio technologies supported by access node 110 and usable by user device 101. In response, access node 110 may direct user device 101 to update its capability report to drive user device 101 to refilter its device capability list.

Access node 110 may wirelessly transfer a command to use device 101 to update its capability report or may transfer a request to core network 120 to deregister user device 101. Deregistration forces user device 101 to reattach to access node 110 and update its capability report. User device 101 selects another device capability based on the radio metric and transfers an updated capability report that indicates the other device capability. Access node 110 establishes a new data link with user device 101 using a new radio technology based on the updated capability report. User device 101 exchanges user data with data network 130 over access node 110 and core network 120 using the new radio technology.

Advantageously, communication network 100 effectively filters user device capabilities based on measured radio conditions and reports the filtered user device capabilities. Moreover, communication network 100 inhibits user device 101 from using radio technologies that are suboptimal for the radio conditions at the location of user device 101.

User device 101 may comprise a phone, computer, vehicle, drone, robot, sensor, or another type of data appliance with wireless and/or wireline communication circuitry. User device 101 and access node 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Access node 110 may comprise a tower, another type of mounting structure (e.g., a building), or no mounting structure at all. Access node 110 may comprise a Sixth Generation (6G) Radio Access Network (RAN) node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Although access node 110 is illustrated as comprising a terrestrial access node, in some examples access node 110 may comprise a non-terrestrial (e.g., satellite based) access node. Access node 110 exchanges network signaling and user data with network functions clustered together into core network 120. Access node 110 is connected to core network 120 over one or more backhaul data links. Access node 110 and core network 120 may communicate via edge networks like internet backbone providers, edge computing systems, or another type of edge system to provide the backhaul data and signaling links between access node 110 and core network 120.

Access node 110 may comprise Radio Units (RUs), Distributed Units (DUs) and Centralized Units (CUs). For example, node circuitry 112 may be representative of a DU and a CU while radio circuitry 111 may be representative of an RU. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user device 101 over access node 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access node 110, core network 120, and data network 130 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form a control plane and a user plane. Exemplary control plane network functions include Access and Mobility Management Function (AMF), Session Management Function (SMF), Unified Data Management (UDM), Policy Control Function (PCF), Mobility Management Entity (MME), Policy and Rules Charging Function (PCRF), Home Subscriber Server (HSS), and the like. Exemplary user plane network functions include User Plane Functions (UPF), Packet Gateway (P-GW), Serving Gateway (S-GW), and the like.

Data network 130 comprises application servers, gateways, routers, Content Distribution Networks (CNDs) and/or other communication devices to participate in data sessions with user device 101. For example, data network 130 may comprise an application server that hosts the server-side component of a user application executing on user device 101. Data network 130 may be representative of a public data network (e.g., the Internet) or a private data network (e.g., an enterprise network). Core network 120 and data network 130 may communicate via links provided by internet backbone providers, edge computing services, and/or other communication services that provide the data links between core network 120 and data network 130.

User device 101 and access node 110 comprise antennas, amplifiers, filters, modulation, analog/digital interfaces, microprocessors, software, memories, transceivers, bus circuitry, and the like. User device 101, access node 110, core network 120, and data network 130 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

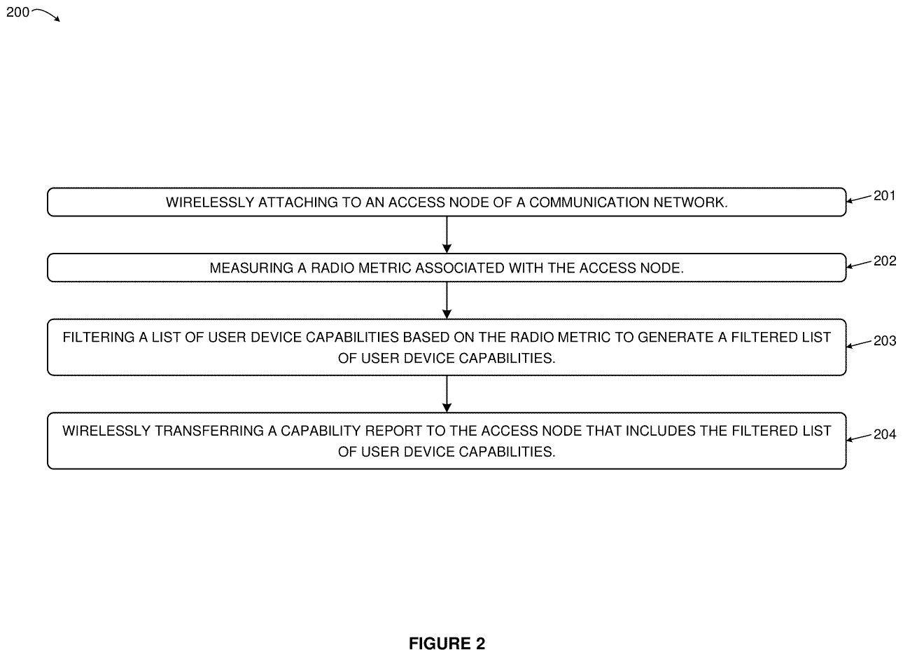

FIG. 2 illustrates process 200. Process 200 comprises an exemplary operation of communication network 100 to selectively report user device capabilities based on measured radio conditions. The operations of process 200 comprise wirelessly attaching to an access node of a communication network (step 201). The operations further comprise measuring a radio metric associated with the access node (step 202). The operations further comprise filtering a list of user device capabilities based on the radio metric to generate a filtered list of user device capabilities (step 203). The operations further comprise wirelessly transferring a capability report to the access node that includes the filtered list of user device capabilities (step 204).

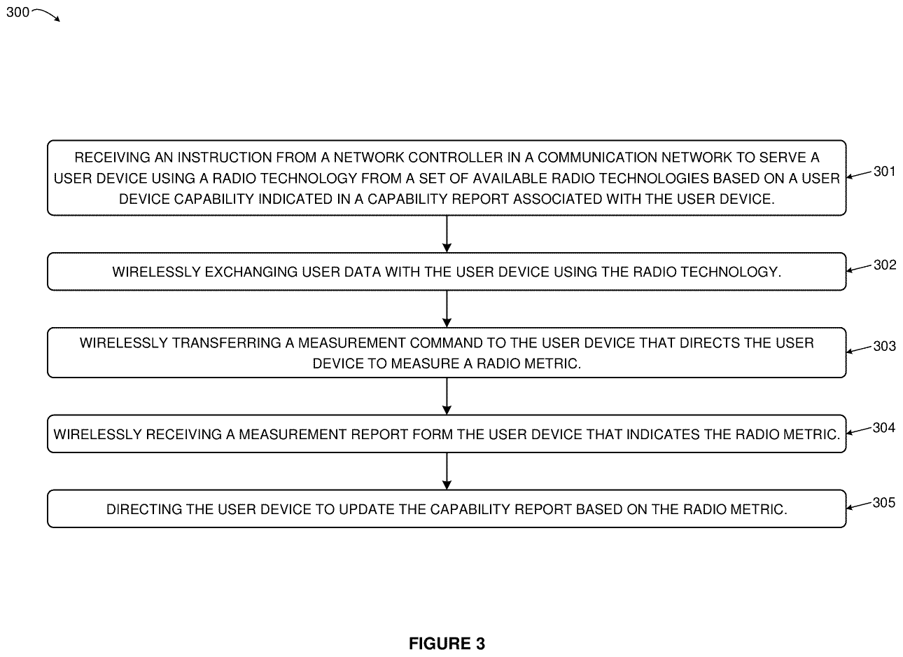

FIG. 3 illustrates process 300. Process 300 comprises an exemplary operation of communication network 100 to selectively report user device capabilities based on measured radio conditions. Process 300 comprises an example of process 200 illustrated in FIG. 2, however process 200 may differ. Process 300 may vary in other examples. The operations of process 300 comprise receiving an instruction from a network controller in a communication network to serve a user device using a radio technology from a set of available radio technologies based on a user device capability indicated in a capability report associated with the user device (step 301). The operations further comprise wirelessly exchanging user data with the user device using the radio technology (step 302). The operations further comprise wirelessly transferring a measurement command to the user device that directs the user device to measure a radio metric (step 303). The operations further comprise wirelessly receiving a measurement report from the user device that indicates the radio metric (step 304). The operations further comprise directing the user device to update the capability report based on the radio metric (step 305). The user device selects a new device capability based on the radio metric and transfers an updated capability that indicates the new device capability.

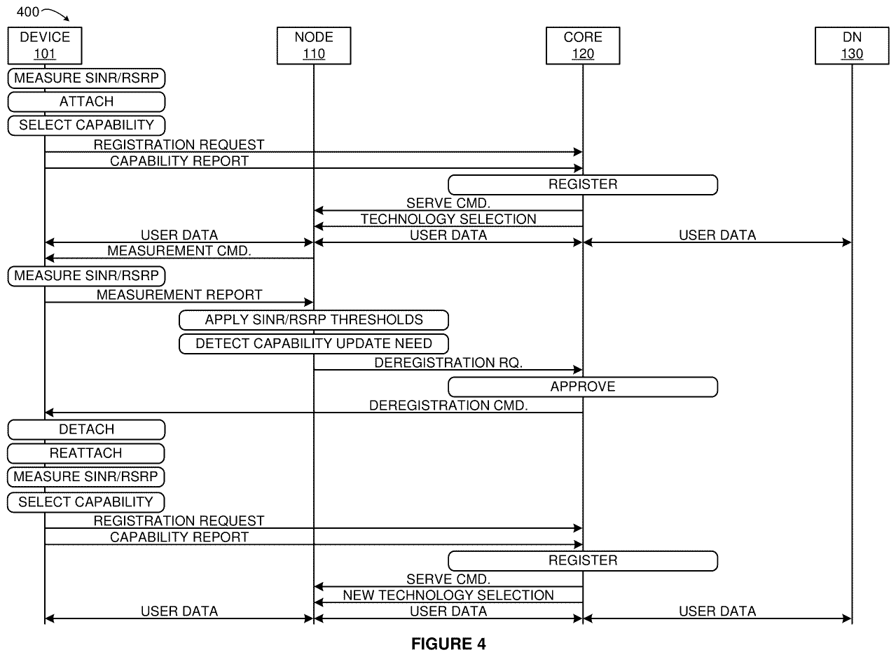

FIG. 4 illustrates process 400. Process 400 comprises an exemplary operation of communication network 100 to selectively report user device capabilities based on measured radio conditions. Process 400 comprises an example of process 200 illustrated in FIG. 2 and process 300 illustrated in FIG. 3, however processes 200 and 300 may differ. Process 400 may vary in other examples. In some examples, radio circuitry 111 in access node 110 broadcasts reference signals. The reference signals include information which is used by user devices to initiate communications with access node 110. User device 101 receives the reference signals and measures SINR, RSRP, and/or other radio metrics (e.g., Received Signal Received Quality (RSRQ)) of the reference signals. When the signal strength of the reference signals exceeds quality and/or strength thresholds, user device 101 attaches to access node 110.

Processing circuitry 103 in user device 101 drives radio circuitry 102 to transfer attachment signaling to node circuitry 112 in access node 110 over radio circuitry 111 based on the reference signals. Node circuitry 112 returns a random access response to processing circuitry 103 in user device 101 over radio circuitry 111 and radio circuitry 102. The response comprises information like a timing advance command, uplink grant, and temporary identifier. Processing circuitry 103 in user device 101 generates and transfers a connection setup request using the uplink grants at the times specified by the timing advance command to node circuitry 112 over radio circuitry 102 and radio circuitry 111. For example, the connection setup request may comprise a Radio Resource Control (RRC) setup request. Node circuitry 112 allocates radio resources to user device 101 to establish a wireless connection with user device 101.

In response to the connection setup, processing circuitry 103 generates a registration request to receive service on communication network 100. User device 101 comprises a set of device capabilities like Time Division Duplex Uplink Massive Input Massive Output (TDD UL MIMO), Uplink Fifth Generation New Radio Carrier Aggregation Time division Duplex and Frequency Division Duplex (UL 5GNR CA TDD/FDD), Power Control 1.5 (PC 1.5), and the like. Some of user device 101's device capabilities are not compatible with other device capabilities of user device 101. For example, user device 101 may not be able to simultaneously utilize TDD UL MIMO and UL 5GNR CA TDD/FDD. Processing circuitry 103 in user device 101 filters its list of device capabilities based on the measured RSRP and SINR. In other examples, user device 101 may filter its list of device capabilities based on other radio metrics. For example, user device 101 may use the Transmit Precoding Matrix Indicator (TPMI) value, RSRQ, buffer status, transmit power, power headroom, access node Radio Access Technology (RAT) type, and the like to filter its list of device capabilities. The filtered list of device capabilities includes device capabilities optimized for the measured RSRP and SINR and excludes device capabilities that are not compatible with the device capabilities included in the filtered list. For example, user device 101 may include TDD UL MIMO in the capability list and exclude UL 5GNR CA TDD/FDD from the capability list when the RSRP and SINR exceed an RSRP threshold and a SINR threshold respectively. Likewise, user device 101 may include UL 5GNR CA TDD/FDD in the capability list and exclude TDD UL MIMO from the capability list when the RSRP and SINR dot exceed the RSRP threshold and the SINR threshold respectively. Exemplary RSRP thresholds range between −70 dBm to −60 d dBm. Exemplary SINR thresholds range between 27 db to 30 db.

Processing circuitry 103 in user device 101 generates a capability report that includes the filtered list of device capabilities. Processing circuitry 103 transfers the registration request to node circuitry 112 over radio circuitry 102 and radio circuitry 111. The registration request includes the capability report and information like subscriber Identifier (ID), Protocol Data Unit (PDU) session request requests, and the like. Node circuitry 112 forwards the registration request to core network 120. Core network 120 authenticates user device 101 and authorizes user device 101 for service on communication network 100. Responsive to authentication and authorization, core network 120 registers user device 101 for service on communication network 100. Core network 120 selects a radio technology to serve user device 101 based on the filtered list of device capabilities included in user device 101's capability report. For example, if user device 101 includes TDD UL MIMO in the capability report, core network 120 may select TDD UL MIMO to serve user device 101.

Core network 120 directs node circuitry 112 in access node 110 to serve user device 101 using the selected radio technology and transfers a registration accept message for user device 101 to node circuitry 112. The registration accept message includes information like device context, network addresses, and/or other information for user device 101 to begin its data session. Node circuitry 112 transfers the registration accept message and indicates the selected radio technology to processing circuitry 103 over radio circuitry 111 and radio circuitry 102. Processing circuitry 103 executes its network applications and user applications to begin its PDU session on communication network 100. The user applications generate user data for the PDU session. Processing circuitry 103 controls radio circuitry 102 to exchange the user data with node circuitry 112 over radio circuitry 111 using the selected radio technology. Node circuitry 112 exchanges the user data with core network 120 which in turn exchanges the user data with data network 130.

Subsequently, node circuitry 112 transfers a measurement command to processing circuitry 103 over radio circuitry 111 and radio circuitry 102. The measurement command directs user device 101 to remeasure SINR and RSRP. For example, node circuitry 112 may periodically direct user device 101 to remeasure SINR and RSRP to maintain an up-to-date picture of the radio conditions at the location of user device 101. Processing circuitry 103 controls radio circuitry 102 to remeasure SINR and RSRP. Processing circuitry 103 transfers a measurement report that indicates the remeasured SINR and RSRP to node circuitry 112 over radio circuitry 102 and radio circuitry 111. Node circuitry 112 compares the SINR and RSRP to a SINR threshold and a RSRP threshold and detects that user device 101 needs to update its device capabilities. In response, node circuitry 112 transfers a deregistration request to core network 120. Core network 120 approves the request, deregisters user device 101, and transfers a deregistration command to processing circuitry 103 in user device 101 over access node 110. The deregistration command forces user device 101 to detach from access node 110 and reregister with communication network 100.

Processing circuitry 103 in user device 101 receives the deregistration command and controls radio circuitry 102 to detach from access node 110. Access node 110 continues to broadcast reference signals. Processing circuitry 103 controls radio circuitry 102 to remeasure SINR and RSRP of the reference signals and decides to attach to access node 110. In response to attaching to access node 110, processing circuitry 103 generates a registration request to receive service on communication network 100. Processing circuitry 103 refilters its list of device capabilities based on the updated RSRP and SINR measurements. The filtered list of device capabilities includes new device capabilities optimized for the updated RSRP and SINR measurements and excludes incompatible device capabilities. Processing circuitry 103 generates an updated capability report that includes the refiltered list of device capabilities. Processing circuitry 103 transfers a registration request to node circuitry 112 over radio circuitry 102 and radio circuitry 111 that includes updated capability report. Node circuitry 112 forwards the registration request to core network 120. Core network 120 reauthenticates user device 101 and reauthorizes user device 101 for service on communication network 100. Responsive to authentication and authorization, core network 120 registers user device 101 for service on communication network 100. Core network 120 selects another radio technology to serve user device 101 based on the refiltered list of device capabilities included in user device 101's updated capability report. For example, if user device 101 includes UL 5GNR CA TDD/FDD in the updated capability report, core network 120 may select UL 5GNR CA TDD/FDD to serve user device 101.

Core network 120 directs node circuitry 112 in access node 110 to serve user device 101 using the selected radio technology and transfers a registration accept message for user device 101 to node circuitry 112. Node circuitry 112 transfers the registration accept message and indicates the selected radio technology to processing circuitry 103 over radio circuitry 111 and radio circuitry 102. Processing circuitry 103 executes its network applications and user applications to begin its PDU session on communication network 100. The user applications generate user data for the PDU session. Processing circuitry 103 controls radio circuitry 102 to exchange the user data with node circuitry 112 over radio circuitry 111 using the newly selected radio technology. Node circuitry 112 exchanges the user data with core network 120 which in turn exchanges the user data with data network 130.

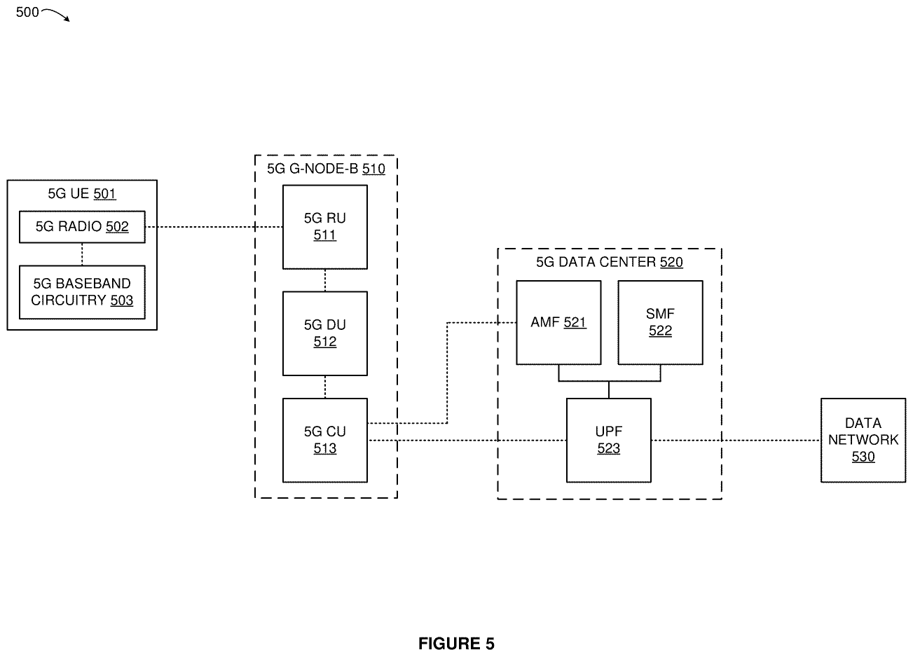

FIG. 5 illustrates 5G communication network 500 to selectively report user device capabilities based on measured radio conditions. 5G communication network 500 comprises an example of communication network 100 illustrated in FIG. 1, however communication network 100 may differ. 5G communication network 500 comprises 5G UE 501, 5G gNodeB 510, 5G data center 520, and data network 530. 5G UE 501 comprises 5G radio 502 and 5G baseband circuitry 503. 5G gNodeB 510 comprises 5G RU 511, 5G DU 512, and 5G CU 513. 5G data center 520 comprises AMF 521, SMF 522, and UPF 523. Other network functions and network entities like Policy Control Function (PCF), Unified Data Management (UDM), Authentication Server Function (AUSF), Network Slice Selection Function (NSSF), Charging Function (CHF), Home Subscriber Register (HLR), Home Subscriber Server (HSS), Network Repository Function (NRF), Unified Data Registry (UDR), Short Message Service Function (SMSF), Network Exposure Function (NEF), Application Function (AF), Equipment Identity Register (EIR), and Session Communication Proxy (SCP) are typically present in 5G data center 520 but are omitted for clarity. In other examples, 5G communication network 500 may comprise different or additional elements than those illustrated in FIG. 5.

In some examples, 5G baseband circuitry 503 controls 5G radio 502 to detect a synchronization signal broadcast by 5G gNodeB 510. 5G radio 502 measures RSRP and SINR of the synchronization signal and reports the measurements to baseband circuitry 503. 5G baseband circuitry 503 decides to attach to 5G gNodeB 510 based on the radio metrics. In response, UE 501 wirelessly attaches to 5G gNodeB 510 over a 5GNR link and baseband circuitry 503 transfers random preamble to 5G gNodeB 510 over 5G radio 502 initiating a Random Access Channel (RACH) procedure to establish a secure signaling channel. 5G gNodeB 510 receives the preamble and assigns a Cell-Radio Network Temporary Identifier (C-RNTI) to UE 501. 5G gNodeB 510 wirelessly transfers a random access response to baseband circuitry 503. The random access response includes a timing advance command, uplink grant, and the C-RNTI. The uplink grant indicates the time and frequency domain resources assigned to UE 501. Baseband circuitry 503 extracts the uplink grant and timing advance command from the response. Baseband circuitry 503 transfers an RRC setup request to 5G gNodeB 510 over 5G radio 502 using the frequency and time resources assigned by the uplink grant at the time indicated by the timing advance command. The RRC setup request comprises a UE identity indication and the establishment cause. 5G gNodeB 510 establishes a radio signaling bearer for UE 501 and transfers an RRC setup message to baseband circuitry 503 over 5G radio 502. The RRC setup message comprises a radio bearer configuration and cell ID. Baseband circuitry 503 establishes an RRC connection with 5G gNodeB 510 over 5G radio 502 using the radio bearer configuration and cell ID.

In this example, UE 501 comprises capabilities for UL 5GNR CA TDD/FDD and TDD UL MIMO. Generally, as the distance between UE 501 and 5G gNodeB 510 decreases and as the SINR at the location of UE 501 increases, the suitability of TDD UL MIMO for uplink transmission increases. Likewise, as the distance between UE 501 and 5G gNodeB 510 increases and as the SINR at the location of UE 501 decreases, the suitability of UL 5GNR CA TDD/FDD for uplink transmission increases. Baseband circuitry 503 infers the distance between UE 501 and 5G gNodeB 510 based on the RSRP measured by 5G radio 502. Baseband circuitry 503 compares the RSRP measured by 5G radio 502 to an RSRP threshold and compares the SINR measured by 5G radio 502 to a SINR threshold to select an uplink UE capability to include in the UE capability report. When the RSRP and the SINR exceed the RSRP threshold and the SINR threshold, baseband circuitry 503 includes TDD UL MIMO in the capability report for UE 501 and excludes UL 5GNR CA TDD/FDD from the capability report for UE 501. Likewise, when the RSRP and the SINR do not exceed the RSRP threshold and the SINR threshold, baseband circuitry 503 includes UL 5GNR CA TDD/FDD in the capability report for UE 501 and excludes TDD UL MIMO from the capability report for UE 501. In situations when the RSRP exceeds the RSRP threshold and the SINR does not exceed the SINR threshold (or vice versa), baseband circuitry 503 includes both UL 5GNR CA TDD/FDD and TDD UL MIMO in the capability report for UE 501. Baseband circuitry 503 modifies the UE capability report based on the RSRP and SINR threshold comparisons.

Baseband circuitry 503 transfers a registration request to AMF 521 over 5G radio 502 and 5G gNodeB 510. The registration request indicates a registration type, 5G-Global Unique Temporary Identifier (GUTI), Tracking Area Identifier (TAI), Network Slice Selection Assistance Information (NSSAI) requests, the UE capability report, PDU session requests, and the like. In response to the registration request, AMF 521 transfers a Non-Access Stratum (NAS) identity request to baseband circuitry 503 over 5G gNodeB 510 and 5G radio 502. Baseband circuitry 503 indicates the Subscriber Concealed Identifier (SUCI) of UE 501 to AMF 521 over 5G radio 502 and 5G gNodeB 510. AMF 521 interfaces with other network functions to authenticate the identity of UE 501. Typically, authentication involves presenting a random number challenge to UE 501 and matching an authentication response from UE 501 with an expected result to verify the identity of UE 501.

Responsive to the authentication, AMF 521 interfaces with other network functions to generate context for UE 501. The UE context defines the authorized services for UE 501. To form the context, AMF 521 retrieves access and mobility subscription data, SMF selection subscription data, and UE context in SMF data from a network data system. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 521 forms the UE context for UE 501 using the retrieved information. AMF 521 interfaces with other network functions to retrieve policy association information for UE 501. The policy association information comprises the SUPI, GPSI, PEI, and user location information for UE 501. In some examples, AMF 521 may interface with other network functions to assign UE 501 to a network slice.

AMF 521 selects SMF 522 to serve UE 501 based on SMF selection data, the policy association information, and/or the network slice assigned to UE 501. AMF 521 transfers a list of requested PDU sessions (as received during the registration request), a PDU session activation command, and the SUPI to SMF 522. SMF 522 receives the PDU session list, session activation command, and the SUPI from AMF 521. SMF 522 allocates IP addresses to UE 501 for the requested PDU sessions and allocates a Tunnel Endpoint Identifier (TEID) for the session. SMF 522 selects UPF 523 to serve UE 501. SMF 522 transfers a session modification request that includes a session endpoint identifier and TEID to UPF 523 to set up the PDU sessions for UE 501. UPF 523 sets up a default bearer for UE 501 with 5G gNodeB 510. The default bearer is a link to carry IP packets for UE 501's PDU session. UPF 523 transfers a session modification response to SMF 522 that includes the session endpoint identifier to confirm bearer setup.

SMF 522 returns a PDU session create response to AMF 521 to confirm session creation. The response includes the updated session context (e.g., allocated IP addresses, TEID, etc.). In response, AMF 521 registers UE 501 for service on 5G data center 520. AMF 521 selects a radio technology to serve UE 501 based on the UE capability report. When the capability report for UE 501 indicates UL 5GNR CA TDD/FDD, AMF 521 selects UL 5GNR CA TDD/FDD as the radio technology to support uplink transmission for UE 501. When the capability report for UE 501 indicates TDD UL MIMO, AMF 521 selects TDD UL MIMO as the radio technology to support uplink transmission for UE 501. When the capability report for UE 501 indicates both UL 5GNR CA TDD/FDD and TDD UL MIMO, AMF 521 selects one of UL 5GNR CA TDD/FDD and TDD UL MIMO as the radio technology to support uplink transmission for UE 501. AMF 521 generates a registration accept message that includes the allocated UE IP address, RAN ID, AMBR, Globally Unique AMF ID (GUAMI), PDU session ID, PDU session TEID, allowed NSSAI list, security data, and the like. AMF 521 instructs 5G gNodeB 510 to serve UE 501 using the selected radio technology. AMF 521 transfers the registration accept message to 5G gNodeB 510 to direct 5G gNodeB 510 to serve UE 501.

5G gNodeB 510 schedules uplink and downlink Physical Resource Blocks (PRBs) for UE 501 to assign time and frequency domain resources for the PDU session based on the registration accept message. 5G gNodeB 510 transfers an RRC reconfiguration message to baseband circuitry 503 over 5G radio 502 to set up the data radio bearers. The message includes cell IDs, bearer configuration information, and the like. 5G gNodeB 510 directs baseband circuitry 503 to use the radio technology for uplink transmission selected by AMF 521. For example, if AMF 521 selects TDD UL MIMO, 5G gNodeB 510 may direct baseband circuitry 503 to use TDD UL MIMO for uplink transmission. 5G gNodeB 510 may indicate the selected radio technology in the RRC reconfiguration message. Baseband circuitry 503 configures its radio bearers using the received information. UE 501 begins its PDU session on 5G communication network 500. Baseband circuitry 503 transfers uplink user data to 5G gNodeB 510 over 5G radio 502 using the selected the radio technology for uplink transmission. 5G gNodeB 510 transfers the uplink user data to data network 530 over UPF 523. Data network 530 transfers downlink user data for UE 501 to 5G gNodeB 510 over UPF 523. 5G gNodeB 510 wirelessly transfers the downlink user data to baseband circuity 503 over 5G radio 502.

During UE 501's PDU session, radio conditions at the location of UE 501 may change. For example, UE 501 may move closer to or farther away from 5G gNodeB 510 due to user mobility or the SINR at the location of UE 501 may change due to an increase or decrease in cell loading. To ensure 5G UE 501 continues to use the appropriate uplink radio technology given the possible change in radio conditions, 5G gNodeB 510 transfers a measurement command to baseband circuitry 503 over 5G radio 502 that directs UE 501 to measure and report RSRP and SINR. Baseband circuitry 503 controls 5G radio 502 to measure RSRP and SINR at the location of UE 501. Baseband circuitry 503 generates a measurement report that includes the updated RSRP and SINR measurements and transfers the measurement report to 5G gNodeB 510 over 5G radio 502.

5G gNodeB 510 infers the distance between UE 501 and 5G gNodeB 510 based on the RSRP measurement included in the measurement report. 5G gNodeB 510 compares the RSRP reported by UE 501 to an RSRP threshold and compares the SINR reported by UE 501 to a SINR threshold to determine if UE 501 needs to update its capability report. When the RSRP exceeds the RSRP threshold, the SINR exceeds the SINR threshold, and UE 501 is currently using UL 5GNR CA TDD/FDD for uplink transmission, 5G gNodeB 510 determines UE 501 needs to update its capability report. Likewise, when the RSRP does not exceed the RSRP threshold, the SINR does not exceed the SINR threshold, and UE 501 is currently using TDD UL MIMO for uplink transmission, 5G gNodeB 510 determines UE 501 needs to update its capability report. In situations when the RSRP exceeds the RSRP threshold and the SINR does not exceed the SINR threshold (or vice versa) or when UE 501 is using the appropriate radio technology for uplink transmission, 5G gNodeB 510 determines that UE 501 does not need to update its capability report.

In some examples, 5G gNodeB 510 may direct UE 501 to update its capability report based on the comparisons. 5G gNodeB 510 may communicate with UE 501 directly to drive UE 501 to update its capability report. For example, 5G gNodeB 510 may transfer an update capability command to baseband circuitry 503 over 5G radio 502. In response to the command, baseband circuitry 503 controls 5G radio 502 to measure RSRP and SINR, compares the RSRP and SINR measurements to their corresponding thresholds, and selects one or more of UL 5GNR CA TDD/FDD and TDD UL MIMO to include in the updated capability report based on the comparisons as described above. Baseband circuitry 503 transfers an updated capability report to 5G gNodeB 510 over 5G radio 502. 5G gNodeB 510 may interface with AMF 521 to select a new radio technology for UE 501 to use for uplink transmissions based on the updated capability report.

In some examples, 5G gNodeB 510 may communicate with AMF 521 to deregister UE 501 to force UE 501 to update its capability report. Network initiated deregistration forces UE 501 to detach from 5G gNodeB 510. 5G gNodeB 510 may transfer a deregistration request to AMF 521. AMF 521 deregisters UE 501 in response to the request and transfers a deregistration command to baseband circuitry 503 over 5G gNodeB 510 and 5G radio 502. Baseband circuitry 503 deletes its current registration context and controls 5G radio 502 to detach from 5G gNodeB 510. Once detached, baseband circuitry 503 controls 5G radio 502 to reattach to 5G gNodeB 510 and measure SINR and RSRP. Baseband circuitry 503 generates an updated capability report that includes one or more of UL 5GNR CA TDD/FDD and TDD UL MIMO based on the threshold comparisons as described above. Baseband circuitry 503 controls 5G radio 502 to transfer a registration request that includes the updated capability report for delivery to AMF 521 to reregister with 5G communication network 500. AMF 521 may select a new radio technology for UE 501 to use for uplink transmissions based on the updated capability report and direct 5G gNodeB 510 to serve UE 501 using the new radio technology.

In some examples, UE 501 may trigger a UE capability report update without receiving an instruction from 5G gNodeB 510. For example, baseband circuitry 503 may set a timer to periodically remeasure RSRP and SINR to maintain an update-to-date picture of the radio conditions at the location of UE 501. In response to expiration of the timer, baseband circuitry 503 may control 5G radio 502 to remeasure RSRP and SINR. Baseband circuitry 503 compares the updated RSRP and SINR measurements to their corresponding thresholds, and selects one or more of UL 5GNR CA TDD/FDD and TDD UL MIMO to include in the updated capability report based on the comparisons as described above. Baseband circuitry 503 transfers an updated capability report and a request to switch radio technology to 5G gNodeB 510 over 5G radio 502. 5G gNodeB 510 may interface with AMF 521 to select a new radio technology for UE 501 to use for uplink transmissions based on the updated capability report.

In some examples, UE 501 may generate a score based on the RSRP and SINR measurements and select UE capabilities to include in the capability report based on the score instead of (or in addition to) the threshold comparisons described above. For example, baseband circuitry 503 may control 5G radio 502 to measure RSRP and SINR of the synchronization signal broadcast by 5G gNodeB 510. Baseband circuitry 503 may then calculate a score by multiplying RSRP and SINR values with weight coefficients and summing the weighted RSRP and SINR values. For example, baseband circuitry 503 may utilize the following equation: Score=(a*RSRP)+(b*SINR) where a and b are the weight coefficients. The resulting score characterizes the overall radio condition at the location of UE 501. Baseband circuitry 503 may compare the score to a radio metric threshold and select one or more of UL 5GNR CA TDD/FDD and TDD UL MIMO to include in the capability report based on the comparison. For example, if the score exceeds the radio metric threshold, baseband circuitry 503 may select TDD UL MIMO to include in the capability report. Likewise, if the score does not exceed the radio metric threshold, baseband circuitry 503 may select UL 5GNR CA TDD/FDD to include in the capability report.

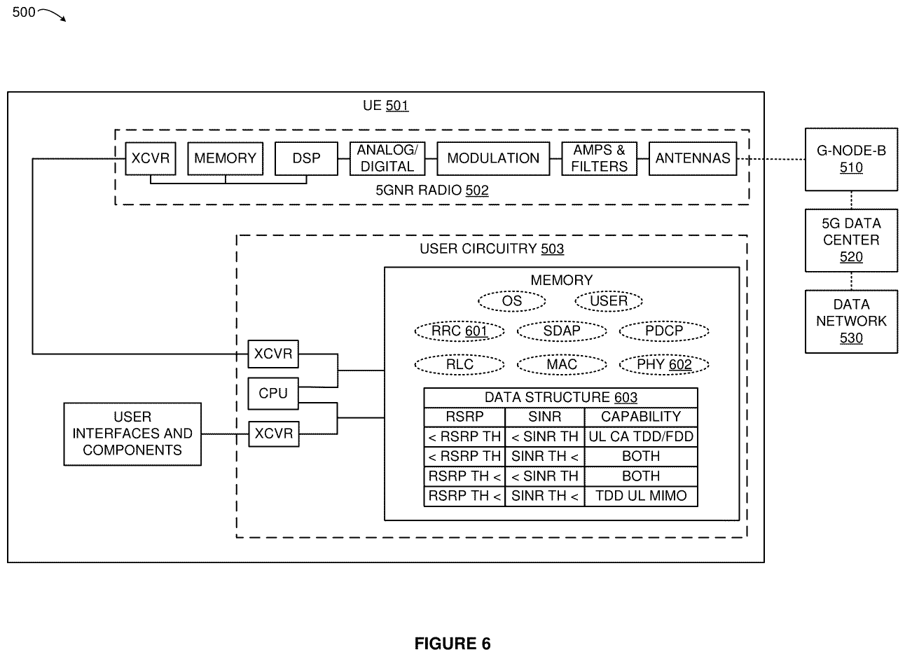

FIG. 6 illustrates UE 501 in 5G communication network 500. UE 501 comprises an example of user device 101 illustrated in FIG. 1, although user device 101 may differ. UE 501 comprises 5G radio 502 and baseband circuitry 503. 5G radio 502 comprises 5GNR antennas, amplifiers, filters, modulation, analog-to-digital interfaces, Digital Signal Processers (DSP), memory, and transceivers (XCVRs) that are coupled over bus circuitry. Baseband circuitry 503 comprises memory, CPU, user interfaces and components, and transceivers that are coupled over bus circuitry.

The memory in baseband circuitry 503 stores an operating system (OS), user applications (USER), data structure 603, and 5GNR network applications for PHY 602, MAC, RLC, PDCP, SDAP, and RRC 601. The antenna in 5G radio 502 is wirelessly coupled to 5G gNodeB 510 over a 5GNR link. Transceivers in radio 502 are coupled to a transceiver in baseband circuitry 503. A transceiver in baseband circuitry 503 is typically coupled to user interfaces and components like displays, controllers, and memory.

In 5G radio 502, the antennas receive wireless signals from 5G gNodeB 510 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to baseband circuitry 503 over the transceivers. In baseband circuitry 503, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 502, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G gNodeB 510 that transport the uplink 5GNR signaling and data.

RRC 601 functions comprise authentication, security, handover control, status reporting, QoS, network broadcasts and pages, network selection, and UE capability filtering. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY 602 functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

Data structure 603 correlates RSRP and SINR measurements to UE capabilities. As illustrated in FIG. 6 when the RSRP and the SINR exceed the RSRP threshold and the SINR threshold, data structure 603 outputs TDD UL MIMO as the UE capability. When the RSRP and the SINR do not exceed the RSRP threshold and the SINR threshold, data structure 603 outputs UL 5GNR CA TDD/FDD as the UE capability. When the RSRP exceeds the RSRP threshold and the SINR does not exceed the SINR threshold (or vice versa), data structure 603 outputs both UL 5GNR CA TDD/FDD and TDD UL MIMO as the UE capabilities. RRC 601 controls the lower layer 5GNR network applications to measure SINR and RSRP and inputs the SINR and RSRP measurements into data structure 603. Data structure 603 compares the RSRP and SINR measurements to their respective thresholds and produces an output that indicates UL 5GNR CA TDD/FDD and/or TDD UL MIMO based on the comparisons. RRC 601 generates a capability report based on the output from data structure 603.

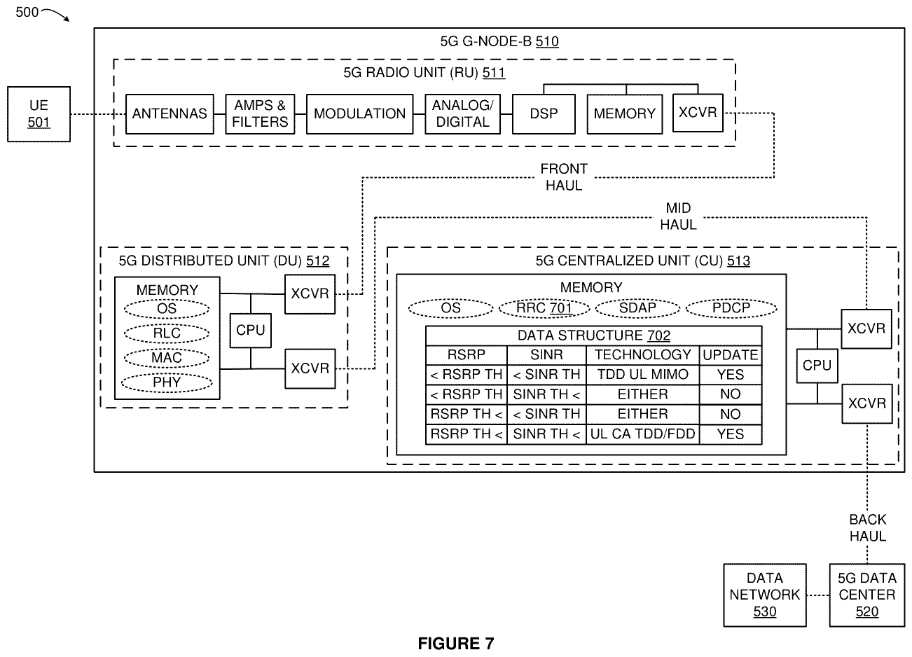

FIG. 7 illustrates 5G gNodeB 510 in 5G communication network 500. 5G gNodeB 510 comprises an example of the access node 110 illustrated in FIG. 1, although access node 110 may differ. RU 511 comprises 5GNR antennas, amplifiers, filters, modulation, analog-to-digital interfaces, DSP, memory, and transceivers (XCVRs) that are coupled over bus circuitry. UE 501 is wirelessly coupled to antennas in RU 511 over 5GNR links. Transceivers in RU 511 are coupled to transceivers in DU 512 over fronthaul links like enhanced Common Public Radio Interface (eCPRI). The DSP in RU 511 executes their operating systems and radio applications to exchange 5GNR signals with UE 501 and to exchange 5GNR data with DU 512.

For the uplink, the antennas in RU 511 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 512 over the transceivers.

For the downlink, the DSPs receive downlink 5GNR symbols from DU 512. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 512 comprises memory, CPU, and transceivers that are coupled over bus circuitry. The memory in DU 512 stores operating systems and 5GNR network applications like PHY, MAC, and RLC. CU 513 comprises memory, CPU, and transceivers that are coupled over bus circuitry. The memory in CU 513 stores an operating system, data structure 702, and 5GNR network applications like PDCP, SDAP, and RRC 701. Transceivers in DU 512 are coupled to transceivers in RU 511 over front-haul links. Transceivers in DU 512 are coupled to transceivers in CU 513 over mid-haul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC 701 functions include authentication, security, handover control, status reporting, QoS, network broadcasts and pages, network selection, and UE capability report updating.

Data structure 702 correlates RSRP/SINR measurements and current uplink radio technology to UE capability report update requirements. As illustrated in FIG. 7 when the RSRP and the SINR exceed the RSRP threshold and the SINR threshold and when the current radio technology is UL 5GNR CA TDD/FDD, data structure 702 produces an output that indicates UE 501 needs to update its capability report. When the RSRP and the SINR do not exceed the RSRP threshold and the SINR threshold and when the current radio technology is TDD UL MIMO, data structure 702 produces an output that indicates UE 501 needs to update its capability report. When the RSRP exceeds the RSRP threshold and the SINR does not exceed the SINR threshold (or vice versa) and when UE 501 is using either UL 5GNR CA TDD/FDD or TDD UL MIMO, data structure 702 produces an output that indicates UE 501 does not need to update its capability report. RRC 701 controls the lower layer 5GNR network applications to transfer a measurement command to RRC 601 in UE 501 that directs UE 501 to measure and report SINR and RSRP. RRC 701 controls the lower layer 5GNR network applications to receive the measurement report from RRC 601. RRC 701 inputs the SINR and RSRP measurements and current uplink radio technology for UE 501 into data structure 702. Data structure 702 compares the RSRP and SINR measurements to their respective thresholds and produces an output that indicates when UE 501 needs to update its capability report. When a capability report update is required, RRC 701 interfaces with AMF 521 to deregister UE 501 or may interface with UE 501 directly to drive UE 501 to update its capability report.

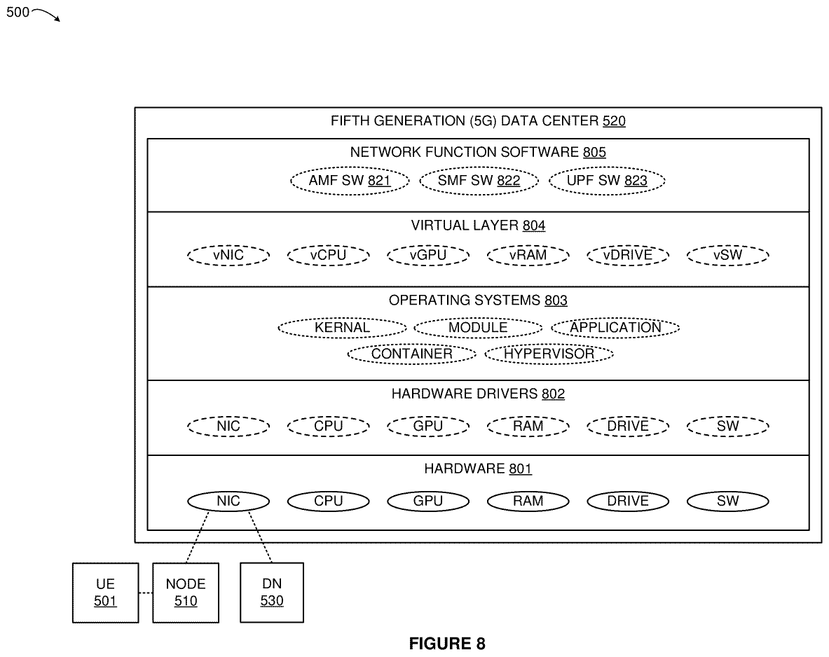

FIG. 8 illustrates 5G data center 520 in 5G communication network 500. 5G data center 520 comprises an example of core network 120 illustrated in FIG. 1, although core network 120 may differ. 5G data center 520 typically comprises a virtualized computing architecture like NFVI, but may comprise another computing architecture like a cloud computing network, a hybrid cloud network, and the like. 5G data center 520 comprises hardware 801, hardware drivers 802, operating systems 803, virtual layer 804, and network function software 805. Hardware 801 comprises Network Interface Cards (NICs), CPU, GPU, RAM, Flash/Disk Drives (DRIVE), and Data Switches (SW). Hardware drivers 802 comprise software that is resident in the NIC, CPU, GPU, RAM, DRIVE, and SW. Operating systems 803 comprise kernels, modules, applications, containers, hypervisors, and the like. Virtual layer 804 comprises vNIC, vCPU, vGPU, vRAM, vDRIVE, and vSW. Network function software 805 comprises AMF Software (SW) 821, SMF SW 822, and UPF SW 823. Additional network function software for network functions like AUSF, NSSF, PCF, UDM, UDR, CHF, HLR, HSS, NRF, SMSF, NEF, AF, EIR, and SCP is typically present but is omitted for clarity. 5G data center 520 may be located at a single site or be distributed across multiple geographic locations. The NIC in hardware 801 is coupled to 5G gNodeB 510, data network (DN) 530, and to external systems (not illustrated). Hardware 801 executes hardware drivers 802, operating systems 803, virtual layer 804, and network function software 805 to form AMF 521, SMF 522, and UPF 523.

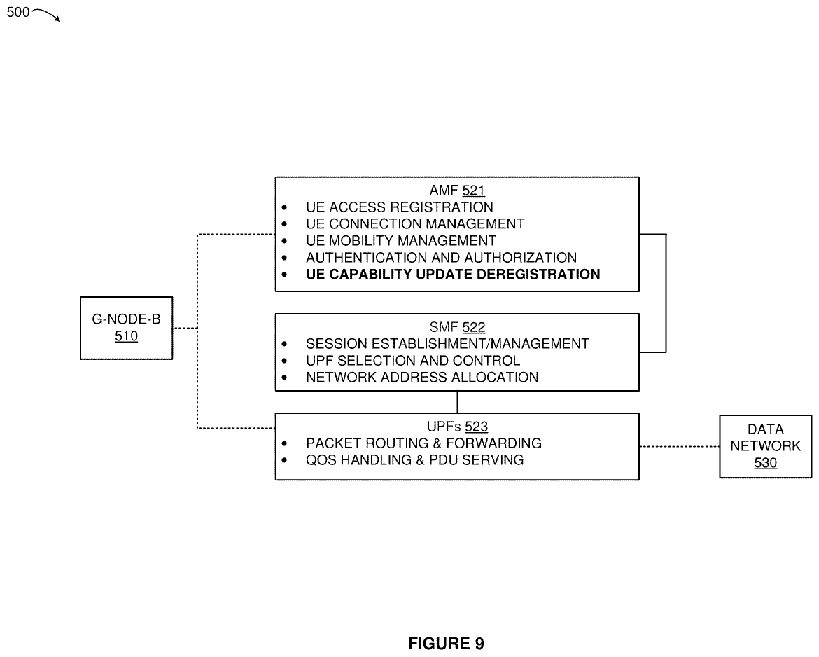

FIG. 9 further illustrates 5G data center 520 in 5G communication network 500. AMF 531 comprises capabilities for UE registration, UE connection management, UE mobility management, authentication, authorization, and deregistration for UE capability report updating. SMF 532 comprises capabilities for session establishment, session management, UPF selection, UPF control, and network address allocation. UPF 533 comprises capabilities for packet routing, packet forwarding, QoS handling, and PDU serving.

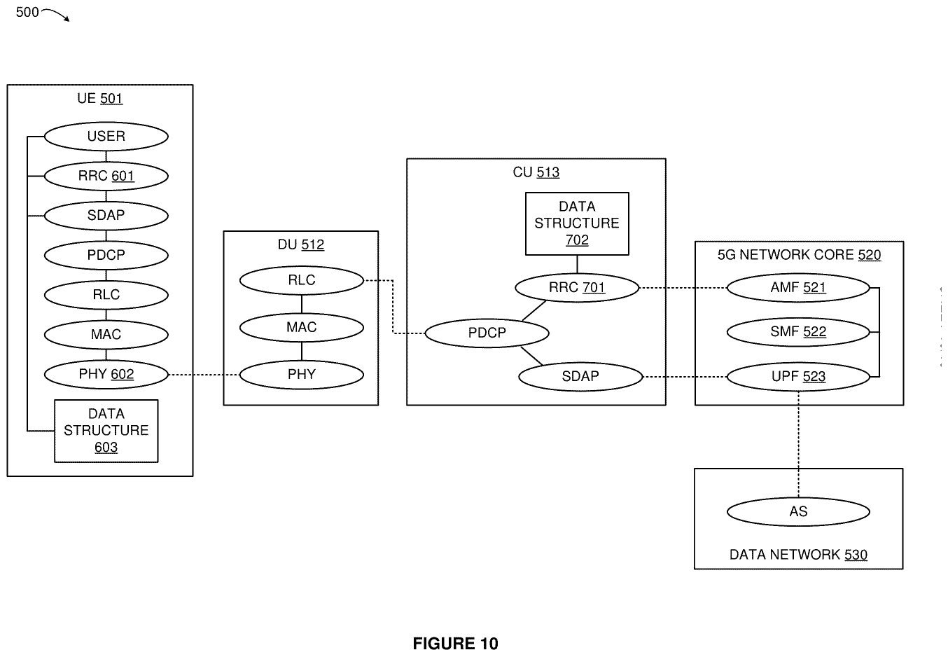

FIG. 10 illustrates an exemplary operation of 5G communication network 500 to selectively report user device capabilities based on measured radio conditions. The exemplary operation comprises an example of process 200 illustrated in FIG. 2, process 300 illustrated in FIG. 3, and process 400 illustrated in FIG. 4, however processes 200, 300, and 400 may differ. The exemplary operation may vary in other examples. In some examples, RRC 601 controls PHY 602 to measure RSRP and SINR of the synchronization signal broadcast by RU 511 in 5G gNodeB 510. PHY 602 measures and reports the RSRP and SINR to RRC 601. RRC 601 elects to attach UE 501 to 5G gNodeB 510 based on the signal measurements. RRC 601 interfaces with RRC 701 over the PDCPs, RLCs, MACs, and PHYs to establish an RRC connection between UE 501 and 5G gNodeB 510. Once the RRC connection is established, RRC 601 inputs the RSRP and SINR measurements into data structure 603. Data structure 603 determines that the RSRP exceeds the RSRP threshold and that the SINR exceeds the SINR threshold. In response, data structure 603 produces an output that selects TDD UL MIMO to include in the UE capability report. RRC 601 filters the UE capabilities based on the output from data structure 603 to generate a UE capability report. The UE capability report indicates TDD UL MIMO as a UE capability but does not indicate UL 5GNR CA TDD/FDD based on the output from data structure 603.

RRC 601 transfers a registration request that includes the capability report to RRC 701 over the PDCPs, RLCs, MACs, and PHYs. RRC 701 forwards the registration request to AMF 521. AMF 521 interfaces with RRC 601 and other network functions in 5G data center 520 to authenticate UE 501. Responsive to the authentication, AMF 521 interfaces with other network functions to generate context and retrieve policy association information for UE 501. AMF 521 selects SMF 522 based on the context and policy association information. AMF 521 directs SMF 522 to serve UE 501. SMF 522 allocates addresses for the session and selects UPF 523 to serve UE 501. UPF 523 sets up a default bearer for UE 501 with 5G gNodeB 510. UPF 523 notifies SMF 522 to confirm bearer setup. SMF 522 transfers a response to AMF 521 to confirm session creation. In response, AMF 521 registers UE 501 for data services.

AMF 521 selects TDD UL MIMO as the uplink radio technology to serve UE 501 based on the UE capability report. AMF 521 generates a registration accept message for UE 501. AMF 521 directs RRC 701 to serve UE 501 using TDD UL MIMO. AMF 521 transfers the registration accept message to RRC 701 to direct 5G gNodeB 510 to serve UE 501. For example, the registration accept message may indicate the radio technologies selected (i.e., TDD UL MIMO) for UE 501 based on the capability report and RRC 701 may control the lower layer network applications to serve UE 501 using the indicated radio technologies. RRC 701 controls the lower layer network applications in CU 513 and DU 512 to wireless data links for UE 501's PDU session. RRC 701 transfers an RRC reconfiguration message to RRC 601 over the PDCPs, RLCs, MACs, and PHYs to setup the data radio bearers. RRC 701 directs RRC 601 to use TDD UL MIMO for uplink transmission. RRC 601 directs the SDAP in UE 501 to begin the PDU session using TDD UL MIMO. The user application in UE 501 generates uplink user data for the PDU session. The SDAP in UE 501 transfers the uplink user data to the SDAP in CU 513 over the PDCPs, RLCs, MACs, and PHYs using TDD UL MIMO. The SDAP in CU 513 transfers the uplink user data to data network 530 over UPF 523. Data network 530 generates and transfers downlink user data for UE 501 to the SDAP in CU 513 over UPF 523. The SDAP in CU 513 transfers the downlink user data to the SDAP in UE 501 over the PDCPs, RLCs, MACs, and PHYs.

During UE 501's PDU session, UE 501 moves from a first location to a second location which causes the RSRP and SINR at the location of UE 501 to decrease. For example, UE 501 may move from a first location in the near cell (i.e., where RSRP and SINR are high) to a second location in the cell edge (i.e., where RSRP and SINR are lower) of 5G gNodeB 510. RRC 701 periodically directs RRC 601 to report radio conditions at the location of UE 501, typically to detect handover conditions. RRC 701 transfers a measurement command to RRC 601 over the PDCPs, RLCs, MACs, and PHYs. RRC 601 controls PHY 602 to remeasure RSRP and SINR of the synchronization signal broadcast by RU 511 in 5G gNodeB 510. PHY 602 measures and reports the RSRP and SINR to RRC 601. RRC 601 generates a measurement report that includes the updated RSRP and SINR measurements. RRC 601 transfers the measurement report to RRC 701 over the PDCPs, RLCs, MACs, and PHYs.

RRC 701 receives the measurement report and inputs the updated RSRP measurement, updated SINR measurements, and data that indicates the current uplink radio technology comprises TDD UL MIMO into data structure 702. Data structure 702 determines that the updated RSRP measurement does not exceed the RSRP threshold, that the updated SINR measurement does not exceed the SINR threshold, and that the current uplink radio technology is TDD UL MIMO. In response, data structure 702 produces an output that indicates that UE 501 needs to update its capability report. RRC 701 transfers a capability update requirement message to RRC 601 over the PDCPs, RLCs, MACs, and PHYs. In response to the message, RRC 601 inputs the updated RSRP and SINR measurements into data structure 603. Data structure 603 determines that the updated RSRP measurement does not exceed the RSRP threshold and that the updated SINR measurement does not exceed the SINR threshold. In response, data structure 603 produces an output that selects UL 5GNR CA TDD/FDD to include in the UE capability report. RRC 601 filters the UE capabilities based on the output from data structure 603 to generate update the UE capability report. The updated UE capability report indicates UL 5GNR CA TDD/FDD as a UE capability but does not indicate TDD UL MIMO based on the output from data structure 603.

RRC 601 transfers the updated capability report and an uplink radio technology change request to RRC 701 over the PDCPs, RLCs, MACs, and PHYs. RRC 701 forwards the request and updated report to AMF 521. AMF 521 approves the request and directs RRC 701 to serve UE 501 using UL 5GNR CA TDD/FDD based on the updated capability report. RRC 701 directs RRC 601 to use UL 5GNR CA TDD/FDD as the uplink radio technology. RRC 601 controls the SDAP in UE 501 to continue the PDU session using UL 5GNR CA TDD/FDD. The user application in UE 501 generates additional uplink user data for the PDU session. The SDAP in UE 501 transfers the uplink user data to the SDAP in CU 513 over the PDCPs, RLCs, MACs, and PHYs using UL 5GNR CA TDD/FDD. The SDAP in CU 513 transfers the additional uplink user data to data network 530 over UPF 523. Data network 530 generates and transfers additional downlink user data for UE 501 to the SDAP in CU 513 over UPF 523. The SDAP in CU 513 transfers the additional downlink user data to the SDAP in UE 501 over the PDCPs, RLCs, MACs, and PHYs.

The wireless data network circuitry described above comprises computer hardware and software that form special-purpose network circuitry to selectively report user device capabilities based on measured radio conditions. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to selectively report user device capabilities based on measured radio conditions.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
wirelessly attaching to an access node of a communication network;
measuring a radio metric associated with the access node;
filtering a list of user device capabilities based on the radio metric to result in a filtered list of user device capabilities; and
wirelessly transferring a capability report to the access node, wherein the capability report includes the filtered list of user device capabilities.

2. The method of claim 1 wherein filtering the list of user device capabilities based on the radio metric to result in the filtered list of user device capabilities comprises:
selecting one or more user device capabilities based on the radio metric;
including the one or more selected user device capabilities in the filtered list of user device capabilities; and
omitting one or more other user device capabilities from the filtered list of user device capabilities that are not compatible with the one or more user device capabilities included in the filtered list of user device capabilities.

3. The method of claim 1 wherein wirelessly transferring the capability report to the access node comprises wirelessly transferring a registration request that includes the capability report to the access node.

4. The method of claim 1 wherein measuring the radio metric comprises measuring Received Signal Received Power (RSRP) and Signal-To-Interference-Plus-Noise Ratio (SINR) associated with the access node.

5. The method of claim 4 further comprising:
comparing the RSRP to an RSRP threshold;
comparing the SINR to a SINR threshold; and wherein:
filtering the list of user device capabilities based on the radio metric comprises filtering the list of user device capabilities based on the comparing of the RSRP and the comparing of the SINR.

6. The method of claim 5 wherein the user device capabilities comprise a Time Division Duplex Uplink Massive Input Massive Output (TDD UL MIMO) capability and an Uplink Fifth Generation New Radio Carrier Aggregation Time division Duplex and Frequency Division Duplex (UL 5GNR CA TDD/FDD) capability.

7. The method of claim 6 wherein filtering the list of user device capabilities based on the comparing comprises selecting the TDD UL MIMO capability when the RSRP exceeds the RSRP threshold and the SINR exceeds the SINR threshold.

8. The method of claim 6 wherein filtering the list of user device capabilities based on the comparing comprises selecting the UL 5GNR CA TDD/FDD capability when the RSRP does not exceed the RSRP threshold and the SINR does not exceed the SINR threshold.

9. The method of claim 4 further comprising:
calculating a weighted sum of the RSRP and the SINR;
comparing the weighted sum to a radio metric threshold; and wherein:
filtering the list of user device capabilities based on the radio metric comprises selecting one of a Time Division Duplex Uplink Massive Input Massive Output (TDD UL MIMO) capability or an Uplink Fifth Generation New Radio Carrier Aggregation Time division Duplex and Frequency Division Duplex (UL 5GNR CA TDD/FDD) capability based on the comparing.

10. A method comprising:
receiving an instruction from a core network in a communication network to serve a user device using a radio technology from a set of available radio technologies based on a user device capability indicated in a capability report associated with the user device;
wirelessly exchanging user data with the user device using the radio technology;
wirelessly transferring a measurement command to the user device that directs the user device to measure a radio metric;
wirelessly receiving a measurement report from the user device that indicates the radio metric; and
directing the user device to update the capability report based on the radio metric wherein the user device selects a new device capability based on the radio metric and transfers an updated capability that indicates the new device capability.

11. The method of claim 10 further comprising:
receiving a new instruction from the core network to serve the user device using a new radio technology from the set of available radio technologies based on the new user device capability indicated in the updated capability report; and
wirelessly exchanging additional user data with the user device using the new radio technology.

12. The method of claim 11 wherein:
the set of available radio technologies comprises a Time Division Duplex Uplink Massive Input Massive Output (TDD UL MIMO) technology and an Uplink Fifth Generation New Radio Carrier Aggregation Time division Duplex and Frequency Division Duplex (UL 5GNR CA TDD/FDD) technology;
the radio technology comprises one of the TDD UL MIMO technology and the UL 5GNR CA TDD/FDD technology; and
the new radio technology comprises one of the TDD UL MIMO technology and the UL 5GNR CA TDD/FDD technology.

13. The method of claim 10 wherein:
wirelessly transferring the measurement command to the user device to measure the radio metric comprises wirelessly transferring the measurement command to the user device to measure Received Signal Received Power (RSRP) and Signal-To-Interference-Plus-Noise Ratio (SINR); and
wirelessly receiving the measurement report from the user device that indicates the radio metric comprises wirelessly receiving the measurement report from the user device that indicates the RSRP and the SINR.

14. The method of claim 13 further comprising:
comparing the RSRP to an RSRP threshold;
comparing the SINR to a SINR threshold; and wherein:
directing the user device to update the capability report based on the radio metric comprises directing the user device to update the capability report based on the comparing of the RSRP and the comparing of the SINR.

15. The method of claim 14 wherein directing the user device to update the capability report comprises directing the user device to update the capability report when the RSRP exceeds the RSRP threshold, the SINR exceeds the SINR threshold, and the radio access technology comprises UL 5GNR CA TDD/FDD.

16. The method of claim 14 wherein directing the user device to update the capability report comprises directing the user device to update the capability report when the RSRP does not exceed the RSRP threshold, the SINR does not exceed the SINR threshold, and the radio access technology comprises TDD UL MIMO.

17. The method of claim 10 wherein:
directing the user device to update the capability report based on the radio metric comprising transferring a request to the core network to deregister the user device; and
the core network deregisters the user device based on the request and the user device selects the new device capability based on the radio metric and transfers the updated capability report that indicates the new device capability in response to the deregistration.

18. The method of claim 10 wherein:
directing the user device to update the capability report based on the radio metric comprises wirelessly transferring an update command to the user device to update the capability report; and
the user device selects the new device capability based on the radio metric and transfers the updated capability report that indicates the new device capability in response to the update command.

19. A system comprising:
radio circuitry of a user device configured to:
wirelessly attach to an access node of a communication network;
measure a radio metric associated with access node;
processing circuitry of the user device configured to:
filter a list of user device capabilities based on the radio metric to result in a filtered list of user device capabilities; and
the radio circuitry further configured to:
wirelessly transfer a capability report to the access node, wherein the capability report includes the filtered list of user device capabilities.

20. The system of claim 19 wherein:
the list of user device capabilities comprises a Time Division Duplex Uplink Massive Input Massive Output (TDD UL MIMO) capability and an Uplink Fifth Generation New Radio Carrier Aggregation Time division Duplex and Frequency Division Duplex (UL 5GNR CA TDD/FDD) capability;
the filtered list of user device capabilities comprises one of the TDD UL MIMO capability or the UL 5GNR CA TDD/FDD capability; and
the radio metric comprises one or more of Received Signal Received Power (RSRP) and Signal-To-Interference-Plus-Noise Ratio (SINR) associated with the access node.
